(19) United States
(12) Patent Application Publication
(10) Pub. No.: US 2020/0307171 A1
(43) Pub. Date: Oct. 1, 2020

(54) PACKAGING BAG COMPRISING A PLASTIC FABRIC COMPOSITE

(71) Applicant: Mondi AG, Wien (AT)

(72) Inventor: Jens KOESTERS, Wallenhorst (DE)

(73) Assignee: Mondi AG, Wien (AT)

(21) Appl. No.: 16/827,929

(22) Filed: Mar. 24, 2020

(30) Foreign Application Priority Data
Mar. 25, 2019 (DE) 10 2019 107 619.6
Mar. 6, 2020 (EP) 20 161 397.3

(51) Int. Cl. B32B 27/12; B32B 5/02; B32B 7/12; B32B 27/32; B32B 37/15; B32B 1/00; B65D 65/40

(52) U.S. Cl. CPC B32B 27/12; B32B 5/02; B32B 7/12; B32B 27/32; B32B 37/15; B32B 2439/46; B65D 65/40; B32B 2307/518; B32B 2255/26; B32B 2255/10; B32B 2439/70; B32B 1/00

(57) ABSTRACT

A packaging bag is made of a plastic fabric composite with a tape fabric formed of intersecting film tapes and with an outer film comprising oriented polyolefin. An acrylate coating is incorporated in the plastic fabric composite, wherein the coating is arranged on the outer film, or an inner film of oriented polyolefin is provided between the outer film and the tape fabric, and the coating is arranged at least on one side of the inner film facing the outer film.

The invention is directed to a packaging bag comprising a plastic fabric composite with a tape fabric formed of intersecting film tapes and with an outer film comprising oriented polyolefin.

Such packaging bags are particularly suitable for large containers having a substantial filling volume and a substantial filling weight. Very large loads can be accommodated as a result of the individual intersecting tapes of the tape fabric. The fact that the film tapes are also oriented as a rule contributes to its particularly high stability. Even in the case of localized damage to the plastic fabric composite, further tearing can be prevented by the individual film tapes.

The composite of tape fabric and outer film results in particular advantages because the different mechanical characteristics complement one another.

The outer film forms a smooth high-quality surface which can also be provided with reverse printing. In the production of the plastic fabric composite, the tape fabric is supplied as premade pre-product and is then connected to the outer film which is likewise generally premade. It should be noted in this regard that the typical laminating process differs fundamentally from the actual production of film in large extrusion installations. Within the framework of the invention, the film which bonds the film tapes and outer film can be formed by blown film extrusion as well as by flat film extrusion.

Such packaging bags can be provided in different constructional forms. In particular, a side gusseted bag can provide a large filling quantity. The present invention also includes such a construction.

A packaging bag with a plastic fabric composite of this kind is known in principle from EP 3 290 206 A1 or EP 3 299 312 A1.

Owing to the favorable mechanical characteristics and the assurance of a tight seal relative to the environment through the outer film, such packaging bags are primarily used for the packaging of foodstuffs, particularly for the packaging of animal foodstuffs.

It has been shown that insects such as beetles or weevil moths are capable of entering the product through the packaging after prolonged storage periods.

In order to combat this problem, it has been proposed in the past that suitable additives be mixed into a film layer of a packaging bag of this kind to keep away insects. A solution of this kind is described in EP 2 857 17 A1, for example, in which a chemical substance which repels insects without harming them is introduced as additive into the polymer composition of the film. A chemical substance of this kind can be citronella. However, admixture of such additives has the drawback that the chemical substances can also have a disadvantageous effect on the packaged foodstuffs. In particular, such chemical substances are often accompanied by a particular odor development that is not only disadvantageous with respect to the packaged foodstuffs but can also be perceived as unpleasant by the potential buyer of such a product.

Therefore, it is the object of the present invention to provide a packaging bag of the type described in the introduction which, on the one hand, is characterized by the simplest possible construction and in which, on the other hand, insects are prevented from entering.

This object is met by a packaging bag according to claim 1. In accordance with claim 1, an acrylate coating is provided in the plastic fabric composite. According to the invention, two embodiment forms have turned out to be particularly suitable. Either the coating is arranged on the outer film or an inner film of oriented polyolefin is provided between the outer film and the tape fabric, and the coating is then arranged on at least one side of the inner film facing the outer film.

Surprisingly, it has turned out that a coating of this kind comprising acrylate effectively prevents the entry of insects. In this regard, it is assumed that these insects emit a secretion which brings about microscopic damages in the outer polyolefin film through which the insects can reach the packaging bag through the plastic fabric composite.

Like the material of the outer film, this insect secretion is nonpolar. In chemistry, polarity refers to a formation of separated charge foci which arises through charge displacement in groups of atoms and as a result of which a group of atoms is no longer electrically neutral. Polar substances comprise polar molecules which are distinguished by a permanent electric dipole moment. The precept that polar materials are highly soluble in polar solvents holds true in this case. But this also applies equally to nonpolar materials and nonpolar solvents. Accordingly, the nonpolar secretion of these insects serves as a solvent for the nonpolar outer film of oriented polyolefin.

Acrylates are polymers based on esters of acrylic acid. Included within the scope of the invention are extrudable acrylates, preferably copolymers of ethylene and acrylates such as ethylene butyl acrylate copolymers (EBA), ethylene ethyl acrylate copolymers (EEA), ethyl methyl acrylate copolymers (EMA) or ethylene acrylic acid copolymers (EAA). The special feature resides in the fact that the ester group imparts a strong polarity to the acrylate so that a layer with high polarity is formed in the plastic fabric composite which is otherwise nonpolar. This polar acrylate layer acts as a barrier layer against the nonpolar secretion of the insects.

In principle, the acrylate coating can be arranged anywhere on the plastic fabric composite, but is preferably provided between the outer film and the tape fabric. However, it also lies within the scope of the invention to arrange the coating outwardly on the outer film or inwardly on the tape fabric in the form of a sealing coating.

The acrylate is applied in the form of a coating. In this respect, different embodiment forms have turned out to be suitable. Within the framework of the invention, a coating basically means the application of a thin but strongly adherent layer of an initially amorphous, e.g., liquid, material. The thickness of a coating of this kind typically ranges from 1 to 10 μm. In the simplest embodiment form, this coating is applied directly to the outer film. The coating is preferably carried out on the side facing the tape fabric. This has the advantage that the acrylate layer does not lead to an optical impairment of the outer film. The coating is applied, for example, via an acrylate lacquer. In a lacquer of this kind, the acrylate is bound in a solution, and the lacquer is applied to a premade film. Alternatively, the acrylate coating can also be coextruded directly with the outer film.

The outer film can have reverse printing. This reverse printing is an internal print produced on the outer film, preferably over the entire surface. Accordingly, the print on the outer film is also carried out on a side facing the tape fabric. In such a case, the outer film is preferably first provided with print on the inner side, and the print is then followed by the acrylate coating. Accordingly, the plastic fabric composite of the packaging bag has a layer construction with the sequence: outer film, print, acrylate coating, tape fabric. This sequence ensures that the print is visible from the outside in spite of the coating.

Alternatively, the acrylate coating can also be arranged directly on the outer film, and internal printing is then carried out on the acrylate coating. Accordingly, the plastic fabric composite of the packaging bag has a layer construction with the sequence: outer film, acrylate coating, print, tape fabric. An arrangement of this kind has the particular advantage that the print itself is also protected from the nonpolar secretion of insects so that the print is not destroyed and an optically high-quality appearance is maintained even if insects penetrate into the outer film. At the same time, the outer film can also be premanufactured with the acrylate coating in a simple matter so that it need merely be joined, e.g., by means of extrusion lamination with the tape fabric in the course of producing the plastic fabric composite.

Alternatively, the print can also be formed as an acrylate layer or can contain acrylate, in which case an acrylate lacquer is preferably used. In this case, the print should be carried out over the entire surface in order to form a closed polar layer.

In order to connect the outer film and the tape fabric together, an intermediate layer is provided via which the outer film and the tape fabric are extrusion-laminated. An extrusion-laminated intermediate layer of this kind is introduced in molten liquid state between the tape fabric and the outer film. When the layer construction formed in this way is acted upon by pressure during the laminating process, particularly in a roll nip, the intermediate layer which is initially still in molten fluid state can adapt to the structure of the tape fabric, which is not completely planar, and can also penetrate to a certain extent into interstices so that a particularly reliable bond and a high laminating strength can be achieved.

When the outer film is coated with acrylate, this intermediate layer preferably directly adjoins the acrylate coating so that the plastic fabric composite has a layer construction with the following sequence: outer film, acrylate coating, intermediate layer, tape fabric. Print, if present, is preferably arranged between the acrylate coating and the outer film or between the acrylate coating and the intermediate layer, in which case the print separates the acrylate coating from the intermediate layer so that the coating cannot function in particular as primer layer. Polypropylene (PP) is particularly suitable as material for the intermediate layer.

While an acrylate coating on the outer film results in a barrier layer which is already effective against the penetration of insects, an additional inner film which is likewise formed from oriented polyolefin can be provided between the outer film and the tape fabric. This inner film then serves as a carrier film for the acrylate coating. Therefore, the outer film can be produced independently from the acrylate coating and, for example, can be provided with print on the back or with reverse printing. Accordingly, the production process for the outer film is governed primarily by visual criteria, while the barrier layer preventing ingress of insects is made possible in a separate production step by providing an inner film on which the acrylate coating is applied. In this respect, the coating can be carried out on each of the two sides of the outer film in principle. Provided the inner film is coated with acrylate on both sides, it is ensured that the barrier layer continues to be effective as a result of the two-sided arrangement even in case of damage to the coating.

If the coating is only on one side, it is preferably arranged on a side of the inner film that faces the outer film. This has the advantage of ensuring that the molten liquid intermediate layer cannot damage the acrylate coating during an extrusion lamination because the inner film ensures a sufficient distance between the acrylate coating and the intermediate layer.

In the embodiment with an inner film as carrier material for the acrylate coating, the coating of the inner film is carried out first and only subsequently joined to the outer film. An adhesive lamination is preferably used for this purpose so that an adhesive layer is arranged between the inner film and the outer film or between the coating and the outer film. The exact arrangement of the adhesive layer is determined by the configuration of the inner film or the arrangement of the coating on the inner film. Insofar as a coating is carried out on the side of the inner film that faces the tape fabric, the adhesive layer is arranged between the inner film and the outer film. In case of a two-sided coating or in case of a coating on the side remote of the tape fabric, the adhesive layer is arranged between the coating and the outer film. Polyurethane (PU) is commonly used as adhesive.

Regardless of whether the coating is applied to the outer film directly or indirectly or is applied to an inner film as carrier material, joining to the tape fabric is preferably carried out in the form of an extrusion lamination as has already been mentioned. This can usually be carried out via an individual intermediate layer. However, it is preferable that two intermediate layers are arranged between the outer film and the tape fabric and between the inner film and the tape fabric, respectively, and a first intermediate layer directly adjoins the tape fabric, and a second intermediate layer directly joins the inner film or the acrylate coating.

A configuration of this kind has the advantage that the material of the individual intermediate layers can be directly adapted to the material of the contacting layers with respect to an optimal laminating strength. Therefore, a configuration of this kind is particularly meaningful when the tape fabric and the inner film are formed from different materials or when one of the intermediate layers directly adjoins the acrylate coating. A bonding joint is formed between the individual intermediate layers. Accordingly, in all, the laminating strength can be optimized only with respect to one intermediate layer. In this respect, a polypropylene copolymer as first intermediate layer and a terpolymer as second intermediate layer have turned out to be particularly advantageous. Accordingly, the intermediate layer of polypropylene copolymer contacts the tape fabric, and the intermediate layer of terpolymer directly contacts the inner film or outer film comprising an oriented polyolefin, the print or the acrylate coating. Of course, the individual intermediate layers are not limited to these two types of polymer but may also be selected correspondingly from other polymers in principle.

Both the inner film and outer film preferably comprise an oriented polyolefin. The polyolefin is preferably polyethylene (PE) or polypropylene (PP). Within the framework of the invention, orientation essentially means the alignment of polymer threads running substantially in the same direction. Orientation of this kind can be achieved, for example, in that the film is stretched in one or more directions. Insofar as the film is stretched in only one direction, the polymer threads can correspondingly be oriented only in this direction, which is referred to as an axial orientation. However, both the inner film and outer film are preferably biaxially oriented, in which case the films are stretched in two directions perpendicular to one another. As a result of the orientation, the films have high tensile strength in the corresponding orientation directions. With a corresponding biaxial orientation, this tensile strength is particularly high in the two directions extending perpendicular to one another.

The subject matter of the invention relates not only to a packaging according to claim 1, but also to a use of an acrylate layer in a packaging bag for the packaging of animal foodstuff as barrier layer against the ingress of insects according to claim 11. An acrylate layer of this kind can always be used as a barrier layer regardless of the specific form of a packaging bag, and plastic fabric composites and traditional film packaging can both be used.

The acrylate layer can be provided in the form of a coating as well as, for example, in the form of a coextruded layer in a film composite for the packaging.

On the whole, an acrylate layer as barrier layer against the incursion of insects has the advantage that additional polar film layers, e.g., polyethylene terephthalate (PET), can preferably be dispensed with. Particularly preferably, the acrylate layer is the only polar layer.

Beyond this, an acrylate layer has the considerable advantage over other polar film layers that the packaging bag can be produced as single-material packaging.

By single-material packaging is meant packaging which is formed substantially from only one material or only one polymer. In the present case, this is preferably single-material packaging based on polyethylene or polypropylene. Accordingly, all of the film layers in a film composite have the same material or are formed from the material of a group such as, in particular, polyethylene or polypropylene, including copolymers thereof. Accordingly, in the case of a plastic fabric composite the tape fabric and the film layers laminated with the tape fabric are likewise produced from the same material. Such single-material packaging has the advantage that it can be recycled in a particularly simple manner because it is not necessary to separate the individual film layers. If, on the other hand, a film layer comprising, for example, polyethylene terephthalate as polar barrier layer were embedded in an otherwise nonpolar film composite of polyethylene or polypropylene, the packaging produced therefrom would have to be split into the individual polymer constituents in an elaborate and cost-intensive process in the course of recycling.

Further, by applying a thin acrylate coating or by incorporating a thin layer of acrylate, a single-material packaging can be assumed because the acrylate contributes only very slightly to the material and is not by itself an independently recyclable film layer. Further, the acrylates that are used can also be ethylene-based copolymers, and the proportion of acrylate in this copolymer is very low compared with the total film composite.

Due to the high degree of polarity of the acrylate-containing layer and the otherwise very thin acrylate coating, a barrier is formed against the nonpolar secretion of insects to a sufficient extent that a correspondingly thick polar film layer and an insect-repelling additive can also be dispensed with.

Subject matter of the invention is, further, a method for the production of a plastic fabric composite for a packaging bag according to claim 17. Accordingly, a first film is supplied and is coated with an acrylate. Subsequently, a tape fabric is supplied and the at least one film is extrusion-laminated with the tape fabric via an intermediate layer. The coating is carried out by applying a liquid layer of acrylate to the at least one film. The layer is first hardened before carrying out the extrusion lamination with the tape fabric. During this, the intermediate layer is introduced in molten liquid form between the tape fabric and the at least one film.

The at least one film is preferably an outer film, and the molten liquid intermediate layer is applied directly to the acrylate coating.

Alternatively, the outer film is imprinted before the extrusion lamination, this printing preferably being carried out on the acrylate coating. Accordingly, the molten liquid intermediate layer is applied on the print in the course of the extrusion lamination.

According to an alternative method, the one film is an inner film, and the inner film is supplied and at least one side, preferably both sides, are coated with a liquid layer of acrylate, and an outer film is supplied subsequently and is connected to the inner film via an adhesive layer. Here again, the layer or layers of acrylate are initially hardened before the adhesive bonding with the outer film is carried out. The outer film is preferably provided beforehand with print, and the print adjoins the adhesive layer. Subsequently, a tape fabric is supplied and is extrusion laminated with the inner film via an intermediate layer.

The invention will be described in the following referring to embodiment examples which are merely exemplary. The drawings show:

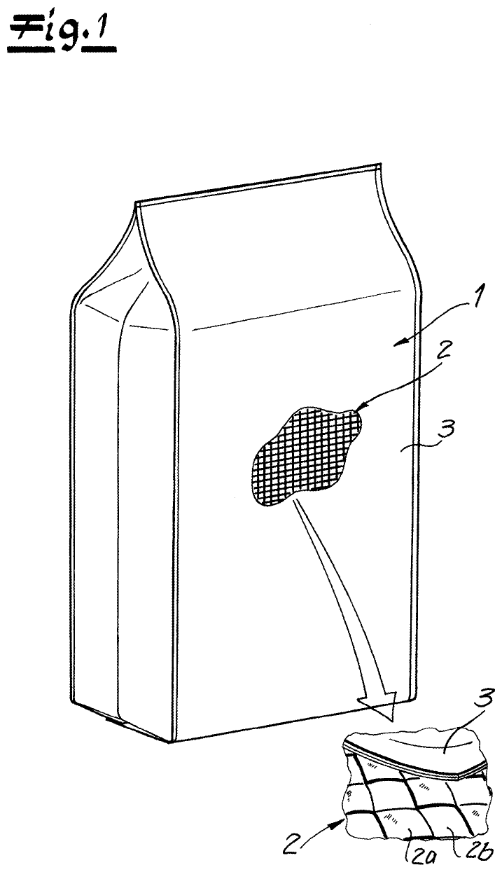

FIG. 1 a packaging bag according to the invention in a perspective schematic view;

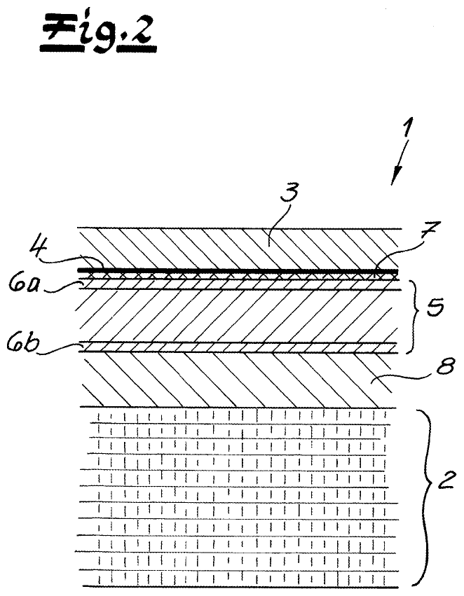

FIG. 2 a layer construction of the plastic fabric composite;

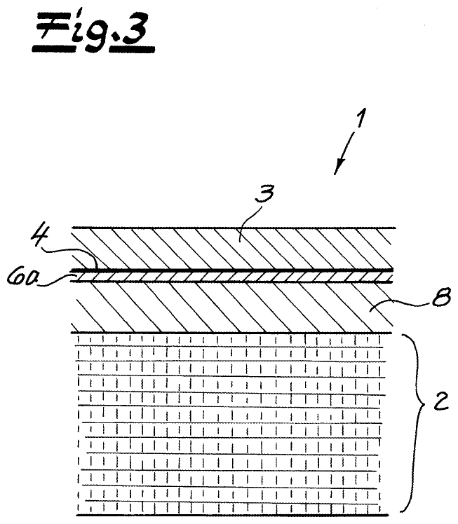

FIG. 3 a layer construction of an alternative configuration of the plastic fabric composite;

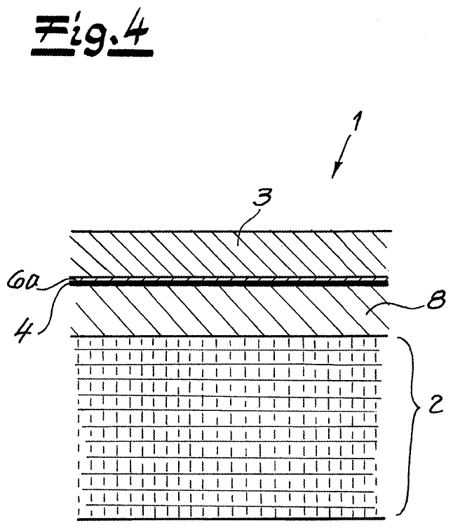

FIG. 4 a layer construction of a further alternative configuration of the plastic fabric composite.

FIG. 1 shows, merely by way of example, a packaging bag which is formed from a plastic fabric composite 1 and which is set up and already filled. The detail shows the tape fabric 2 of intersecting film tapes 2a and 2b. This tape fabric 2 is arranged internally in the packaging bag. The packaging bag is tightly sealed against the environment by an outer film 3. The outer film 3 comprises a biaxially oriented polyolefin, e.g., polypropylene or polyethylene. The enlarged view of the detail further shows that, apart from the tape fabric 2 comprising intersecting film tapes 2a and 2b and the outer film 3, the film arranged outwardly over the tape fabric 2 is formed of a plurality of layers, and the outer film 3 is the outwardly terminating layer.

The layer construction shown already by way of example in FIG. 1 is made particularly clear by a comparison with FIG. 2.

FIG. 2 shows the layer construction of the plastic fabric composite 1 by a cross section through the material. First, the tape fabric 2 is arranged on the inside, while the outer film 3 is the terminating layer on the outer side. Print 4 is provided on the inner side of the outer film 3 and is applied directly to the outer film 3.

Due to the fact that the print 4 is arranged on the inner side of the outer film 3, the outer film 3 itself acts as a protective layer for the print 4 to prevent the print 4 from being damaged or worn off. In this way, it is ensured that the visual appearance of the packaging bag is not impaired, for example, as a result of transporting or due to prolonged storage, since this visual appearance is a key aspect in the consumer's purchasing decision.

Further, an inner film 5 is provided between the outside film 3 with the print 4 and the tape fabric 2. Like the outer film 3, the inner film 5 is also formed from an oriented polyolefin, e.g., polyethylene or polypropylene. This inner film 5 has, on both sides, a coating 6a, 6b with an acrylate so that this inner film 5 acts as carrier material for the coatings 6a, 6b. Acrylate coating 6a is arranged on a side of the inner film 5 facing the outer film 3 and coating 6b is arranged on a side of the inner film 5 facing the tape fabric 2. As a result of acrylate coatings 6a, 6b, the inner film 5 which is itself produced from a nonpolar polymer has a layer of a polar material, namely, acrylate, on both sides. A permeating damage to the plastic fabric composite 1 due to nonpolar solvents can be prevented by means of such a polar coating 6a, 6b of acrylate. That is, as a general rule, only nonpolar solvents can dissolve a nonpolar film layer and only polar solvents can dissolve a polar film layer so that in the case of a nonpolar solvent, for example, the dissolving process would be stopped at the latest at the coating 6a, 6b.

Therefore, for example, if an insect secretes a nonpolar secretion on the outer film 3, this would result in localized damage to the outer film 3. However, a dissolving of the plastic fabric composite 1 could then be stopped at the latest at coating 6a so that this insect would be prevented from penetrating into the interior of the packaging bag.

Further, the second coating 6b provides a two-fold protection insofar as, for example, coating 6a would be locally damaged through other influences, e.g., mechanical influences. In this case, the insects could cause damage to the inner film 5, but the dissolving process would be stopped at the latest at coating 6b.

Further, in order to connect the outer film 3 to the inner film 5 an adhesive layer 7 is provided which connects the two films 3, 5. Since the inner film 5 has a coating 6a, 6b of acrylate on both sides and the outer film 3 has an internal printing 4, the adhesive layer 7 is arranged between the print 4 and the outer acrylate coating 6a.

After producing the film composite comprising outer film 3, print 4, adhesive layer 7, coating 6a, inner film 5 and coating 6b, this film composite is fastened to the tape fabric 2. For this purpose, an intermediate layer 8 is provided, and an extrusion lamination of the film composite with the tape fabric 2 is carried out via this intermediate layer 8. To this end, the material of the intermediate layer 8 is introduced in molten liquid state between the film composite and the tape fabric 2 and is cooled accompanied by the application of pressure to both sides so that the initially molten liquid material of the intermediate layer 8 solidifies. This results in a laminating adhesion of the film composite to the tape fabric 2 so that the whole plastic fabric composite 1 can be formed in this way. An additional laminating strength is achieved in that the intermediate layer 8 at least partially penetrates into the tape fabric 2 in molten liquid state such that the contact surface between the intermediate layer 8 and the tape fabric 2 is made larger.

Polypropylene is particularly suitable as material for the intermediate layer 8 so that the outer film 3, inner film 5 and intermediate layer 8 can all be produced from the same material. Polypropylene is also preferably used for the film tapes 2a, 2b of the tape fabric 2 so that a single-material packaging can be formed in principle. Since the print 4, the adhesive layer 7 and the coatings 6a, 6b can be formed particularly thin, they make up only a very small proportion of the total material of the plastic fabric composite 1. Therefore, packaging or a packaging bag of this kind is still defined as single-material packaging. This has special advantages in the recycling process because there is no need to separate the individual polymer constituents. Nevertheless, a polar barrier layer or polar barrier layers which effectively prevent penetration by insects are embedded in the plastic fabric composite 1 by means of the thin coatings 6a, 6b of acrylate.

In this regard, FIG. 3 shows an alternative embodiment form of the plastic fabric composite 1 which dispenses with an inner film 5 as carrier material for the coatings 6a, 6b. Coating 6a is carried out directly on the outer film 3. Print 4 is first arranged on the outer film 3 and the acrylate coating 6a is then arranged on this print 4. For example, the coating 6a can be a printed, full-surface layer of an acrylate lacquer.

Because the inner film 5 is absent, an adhesive layer 7 can also be dispensed with so that the outer film 3 with the print 4 and the acrylate coating 6a is extrusion-laminated with the tape fabric 2 directly via an intermediate layer 8.

However, care must be taken that the intermediate layer 8 does not damage the acrylate coating 6a because, in contrast to the embodiment shown in FIG. 2, there is no second barrier layer or second acrylate coating 6b. However, in contrast to the embodiment shown in FIG. 2, the production process is simpler and there is less material used.

Further, it is conceivable that the intermediate layer 8 has not one, but two layers with a first intermediate layer and a second intermediate layer, and the individual intermediate layers can then be directly adapted to the material contacting them so that the best possible laminating adhesion is formed between the individual intermediate layers and the contacting material.

FIG. 4 shows the layer construction of a further alternative embodiment form. The individual layers conform to the embodiment form according to FIG. 3, although the layer sequence differs in the embodiments. Accordingly, the acrylate coating 6a directly adjoins the outer film 3. The print 4 is not provided directly on the outer film 3 but rather on the coating 6a. Therefore, during production, coating 6a is initially applied to the outer film 3. This can be carried out, for example, by applying an acrylate lacquer. Alternatively, the outer film 3 and acrylate coating 6a are coextruded. Only then is the print 4 carried out. The outer film 3 with the acrylate coating 6a and the print 4 is then fastened to the tape fabric 2 via an intermediate layer 8. In this case also, the intermediate layer 8 is an extrusion layer via which the outer film 3 is extrusion-laminated with the tape fabric 2.

1. A packaging bag comprising a plastic fabric composite with a tape fabric formed of intersecting film tapes and with an outer film comprising oriented polyolefin, wherein an acrylate coating is incorporated in the plastic fabric composite, wherein the coating is arranged on the outer film, or an inner film of oriented polyolefin is provided between the outer film and the tape fabric, and the coating is arranged at least on one side of the inner film.

2. The packaging bag according to claim 1, wherein the acrylate coating is arranged between the outer film and the tape fabric.

3. The packaging bag according to claim 1, wherein the outer film and the tape fabric are extrusion-laminated through at least one intermediate layer.

4. The packaging bag according to claim 1, wherein the outer film has print on a side facing the tape fabric.

5. The packaging bag according to claim 4, wherein the print is arranged on the acrylate coating.

6. The packaging bag according to claim 1, wherein the coating is arranged on both sides of the inner film.

7. The packaging bag according to claim 1, wherein an adhesive layer is arranged between the inner film and the outer film or between the coating and the outer film.

8. The packaging bag according to claim 1, wherein the outer film and the tape fabric are extrusion-laminated through two intermediate layers, wherein a first intermediate layer directly adjoins the tape fabric and a second intermediate layer directly adjoins the coating or the inner film.

9. The packaging bag according to claim 8, wherein the first intermediate layer is formed from a polypropylene copolymer and the second intermediate layer is formed from a terpolymer.

10. The packaging bag according to claim 1, wherein the oriented polyolefin of the inner film and/or of the outer film is biaxially oriented.

11. The packaging bag according to claim 1, wherein the oriented polyolefin of the inner film and/or of the outer film is polypropylene.

12. The packaging bag according to claim 1, wherein the film tapes of the tape fabric are formed from polypropylene.

13. A use of an acrylate layer in a packaging bag for packaging animal foodstuff as barrier layer against the ingress of insects.

14. The use according to claim 13 with the provision that the acrylate layer is the only polar barrier layer.

15. The use according to claim 13 with the provision that the packaging bag is a single-material bag.

16. The use according to claim 13 with the provision that the packaging bag is formed so as to be based on polyethylene or polypropylene.

17. A method for the production of a plastic fabric composite (1) for a packaging bag according to claim 1, wherein a first film is supplied and is coated on at least one side with an acrylate, wherein a tape fabric is supplied subsequently and the one film is extrusion-laminated with the tape fabric via an intermediate layer.
